(19) United States
(12) Patent Application Publication
(10) Pub. No.: US 2007/0106705 A1
(43) Pub. Date: May 10, 2007

(54) System and method for integrating data between computer systems

(76) Inventor: Vikram Chalana, Mill Creek, WA (US)

Correspondence Address: BLACK LOWE & GRAHAM, PLLC, 701 FIFTH AVENUE, SUITE 4800, SEATTLE, WA, 98104, US

(21) Appl. No.: 11/556,943

(22) Filed: Nov. 6, 2006

Related U.S. Application Data
(60) Provisional application No. 60/734,051, filed on Nov. 7, 2005.

(51) Int. Cl. G06F 17/30

(52) U.S. Cl. 707/201

(57) ABSTRACT

Data within database and/or spreadsheet programs of a first computer system are made recognizable by a second computer system. The recognizable data serves to facilitate either data processing within the first computer system by instructions received from the second computer system and/or to transfer the recognizable data of the first computer system to the database and/or spreadsheet program of the second computer system for subsequent processing by the second computer system.

### PRIORITY CLAIM

This application claims priority to U.S. provisional patent application Ser. No. 60/734,051 filed Nov. 7, 2005 and is incorporated by reference in its entirety as if fully set forth herein.

### FIELD OF THE INVENTION

An embodiment of the invention relates generally to methods of integrating data from non-natively compatible spreadsheets or databases located on different computer systems.

### BACKGROUND OF THE INVENTION

Many computer systems located in different locations are architecturally organized to include satellite or auxiliary computer systems that are in signal communication with a central computer system. The central computer system often provides enterprise resource planning (ERP) software applications for processing data provided from the auxiliary computer systems. Businesses and other organizations having these auxiliary computer systems commonly employ spreadsheet based databases that require integration into the central ERP system software applications. Oftentimes, the ERP software applications are not natively compatible with the auxiliary spreadsheet databases and thus present difficulty for data integration in that the alphanumeric content of the auxiliary and central databases are heterogeneously different in form and structure, and oftentimes in content.

Current data integration procedures between auxiliary databases and within ERP systems are either very slow or very complicated. Slow procedures often require manual reentry of alphanumeric data from the auxiliary database into the central ERP database, thus duplicating the effort. Complicated procedures are exemplified by the development of specialized software integration programs by information technology programmers who subsequently train an organization's technical staff to implement the integration programs. Another example of complicated procedures employ the learning and adaptation of ERP program-specific “automation tools” that are not that automatic or easy to use. Both manual and complicated procedures are costly to an organization to engage or adopt and often is error prone. Accordingly, there is a need for a non-manual and non-custom programmable method that permits an untrained individual or workforce to cost effectively and efficiently integrate data between non-compatible auxiliary and central ERP databases.

### SUMMARY OF THE INVENTION

An embodiment of the invention includes a system and method of using a software application program designed to facilitate data transfer and integration between non-compatible spreadsheet and database programs residing on separate computer systems or partitioned within the same computer system such that the transferred and integrated data is made recognizable and amenable to data processing by the previously incompatible spreadsheet or database programs. The software application program utilizes an integration tool that transfers or shuttles non-natively compatible data between spreadsheet or database software processing programs, render the non-natively compatible data to recognizable and compatible form, such that the transferred and transformed data is amenable to processing by the spreadsheet and/or database programs located on different computer systems or portioned within the same computer system.

### BRIEF DESCRIPTION OF THE DRAWINGS

Embodiments of the present invention are described in detail below with reference to the following drawings.

FIG. 1 schematically illustrates satellite computer systems having legacy spread sheet programs and databases in communication with a central computer having software spread sheets and databases run from an ERP system;

FIG. 2 is a pictographic and schematic illustration of a data integration system;

FIG. 3 illustrates a method of data integration between computer systems using single and multiple line sampling according to an embodiment of the invention;

FIG. 4 is an expansion of sub-algorithm 74 of FIG. 3;

FIG. 5 is an expansion of sub-algorithm 76 of FIG. 3;

FIG. 6 is an expansion of sub-algorithm 84A of FIG. 3;

FIG. 7 is an expansion of alternate sub-algorithm 84B of FIG. 3;

FIG. 8 is an expansion of sub-algorithm 102 of FIG. 6;

FIG. 9 is an expansion of sub-algorithm 108 of FIG. 6;

FIG. 10 is an expansion of sub-algorithm 113 of FIG. 6;

FIG. 11 depicts a screenshot of a general ledger ERP screen as an example of pre-validating a single line item data prior to posting;

FIG. 12 depicts a screenshot of the integration tool mapping the general ledger fields to a spreadsheet file as an example of pre-validating the multiple lines of selected spreadsheet files data prior to posting;

FIG. 13 depicts a screenshot demonstrating the results of prevalidation of the selected files from FIG. 12; and

FIGS. 14-17 presents a series of screen shots related to the Do-While Loop feature of the integration tool.

### DETAILED DESCRIPTION OF THE PARTICULAR EMBODIMENTS

In general, particular embodiments include systems and/or methods to integrate data between databases and/or spreadsheet programs of a first computer system and a second computer system in which the data exists in different alphanumeric configurations that is not natively compatible to be executable by programs stored within the databases and/or spreadsheet programs operated by the respective first and second computer systems. The integration of data includes reformatting the data on the first computer for transfer to and running by the second computer's spreadsheet and/or database programs, or transferring to the second computer, reformatting by the second computer, or any intervening server, and executing by the second computer's programs. Other particular embodiments mapping or association of data between any two computer systems having different database and/or spreadsheet programs within the same screenshot, or series of screenshots, of either the first or second computer systems. Yet other particular embodiments include pre-validation to confirm that reformatted data is compatible by the running of a sample of the reformatted data to verify the results thereof for integrity and accuracy.

Data integration may be accomplished by a software application having data integration tools and methods of using thereto that transfers and makes previously incompatible data to a compatible form. The integration tool and methods of using may be designed to 1, transfer substantially incompatible data between a first and a second computer system having different database and/or spreadsheet programs; 2, reformat the transferred data into compatible forms executable by the first or second computer's program; 3, to confirm that the reformatted data is accurately transferred by running a single or multi-line sampling of the first computer's reformatted data by the second computer's programs, or the second computer's reformatted data by the first computer's program; 4, upon confirmation of accurate sample transfer, running the remainder of the line-items according to the reformatting procedures that generated accurate sample processing.

Other particular embodiments allow for data within a database and/or spreadsheet program of a first computer system are made recognizable by a second computer system. The recognizable data serves to facilitate either data processing within the first computer system by instructions received from the second computer system and/or to transfer the recognizable data of the first computer system to the database and/or spreadsheet program of the second computer system for subsequent processing by the second computer system.

In the case where the second computer utilizes ERP programming, pre-validation includes sampling and mapping of alphanumeric and/or categorical data within a first computer's database or spreadsheet program to the ERP may be sampled, mapped or linked with the enterprise resource planning configurations. Upon confirmation of sampling accuracy and transfer to the ERP database, the remaining data from the auxiliary database may be processed according to the sampled data and transferred to the ERP database.

For example, data within a Microsoft Excel® and/or Microsoft Access® auxiliary database located within the first computer system, or otherwise known as a satellite, auxiliary, or primary computer system is made recognizable by software applications contained within a central database and/or spreadsheet program located in second computer system, such as a central ERP computer system. For example, in an ERP system having accounting based software programs such as SAP®, Oracle®, PeopleSoft® and TABS® applications, a portion of the Microsoft Excel® and/or Microsoft Access® data in the auxiliary system is made recognizable by either SAP®, Oracle®, PeopleSoft® and/or the TABS® applications. The alphanumeric data is often in the form of and not limited to transactional data having qualitative, quantitative, integer, fractional, mixed integer and fraction, and descriptive categorical fields, or any combination thereof. The recognizable data serves to facilitate either data processing within the auxiliary database by instructions received from the central computer system and/or to transfer the recognizable data of the auxiliary or database to the central or second database for subsequent processing by the central computer system.

One embodiment provides for an integration tool that includes a transfer function and a method that can be used by business end-users to upload transactional data from spreadsheets to ERP systems without requiring any programming. The transactional data includes financial data such as journal vouchers and invoices, and logistics data such as purchase orders and sales orders. The automation transfer tool facilitates the uploading transactional data by establishing the ability to handle data containing header data and multiple line items, and to minimize errors and pre-validate data before posting it into accounting system databases. The number of multiple line items may be known in advance, i.e. a-priori, or not known in advance.

In a particular embodiment, the integration tool involves advantageously shuttling or delivering data stored in ERP-like spreadsheet and/or database programs residing in a secondary computer system, for example SAP®, to spreadsheet and/or database programs occupying a first computer system, for example Microsoft's Excel®, Microsoft's Access®, Sun Microsystem's StarOffice®.

One of the common characteristics of most transactional data that make the use of data automation transfer tools difficult is that each transaction may have header data followed by several or multiple line items. In this case the integration tool provides additional functionality so that a transactional document with any number of line items can still be posted from spreadsheets to the ERP system. One of the features that the integration tool of the invention provides to handle such data is the ability to loop over the line items data fields. Such a looping functionality allows documents with many different line items, where the number of items is not known a-priori, to be posted from the spreadsheet into the ERP system.

When spreadsheets containing multiple line items are prepared for posting into the ERP system, the data in these spreadsheets may contain errors that would prevent the posting of the data into the ERP. This invention provides features that minimize the errors in the data and that rapidly pinpoint the line items containing the errors. The minimization of errors is achieved by providing a list of choices for each data entry. In addition, a special pre-validation recording created using the automation transfer tool itself pinpoints the line item containing errors.

Particular embodiments are described in the following figures illustrating systems, auxiliary to central computer system uploading methods, central computer system to auxiliary down load methods, and illustrative examples of spreadsheet screenshots.

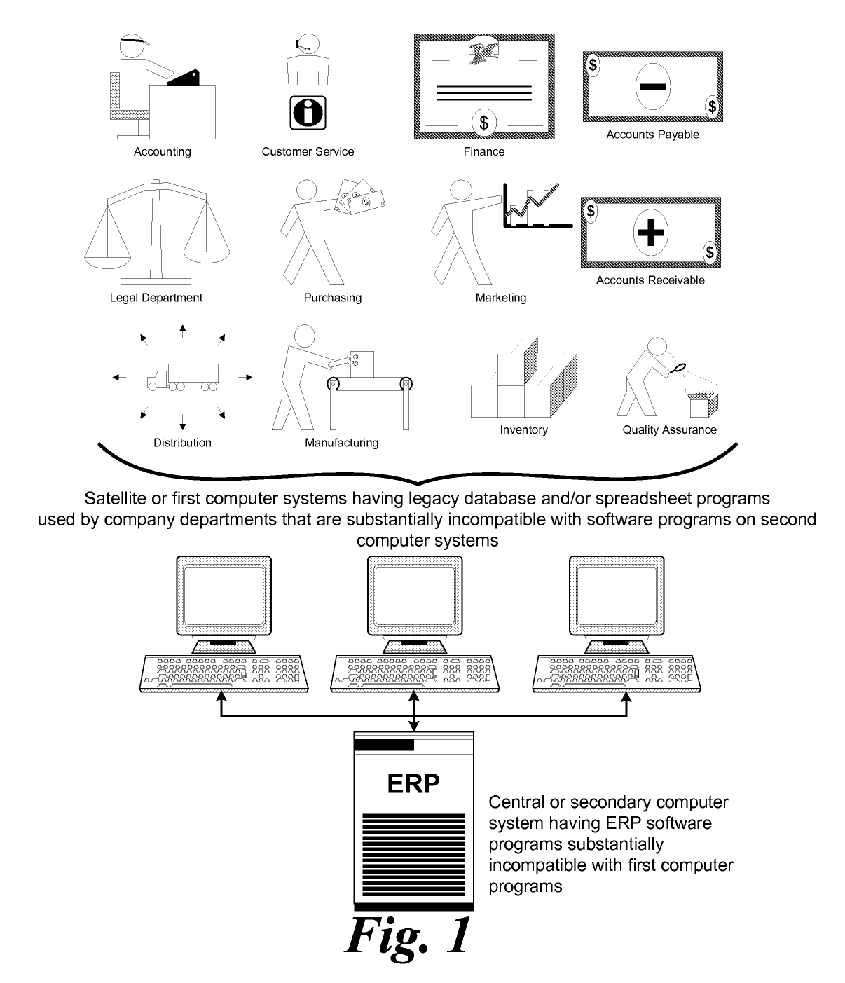

FIG. 1 pictographically and schematically illustrates several first or primary or satellite computer systems having legacy spread sheet programs and/or databases in communication with a central computer having software spread sheets and/or databases run from a second or ERP system. By way of example, multiple departments of a company or other organization that use at least one, or several first computers having non-compatible databases and/or spreadsheet software programs in communication with a secondary or central ERP system. Pictographically illustrated are accounting, customer service, finance, accounts payable, accounts receivable, marketing purchasing, legal, manufacturing, inventory, quality assurance, and distribution departments using the primary computers having the legacy database and/or spreadsheet programs. The primary computers may be in two-way communication with the ERP computer system.

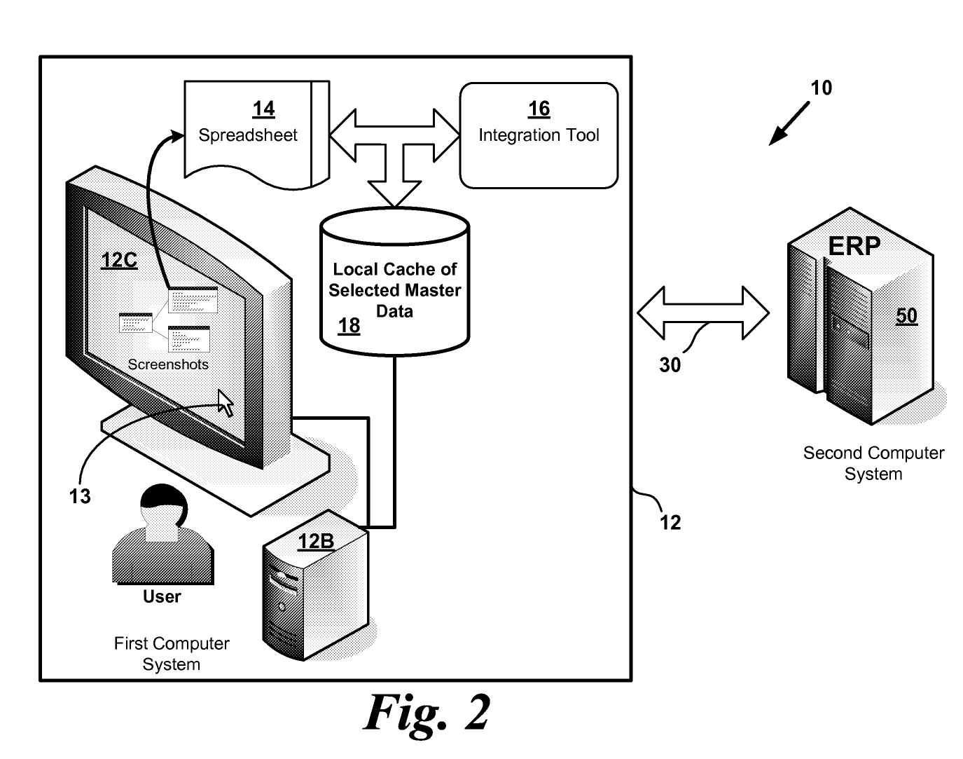

FIG. 2 is a pictographic and schematic illustration of a data integration system 10. The data integration system 10 includes a first computer system 12 in signal communication with a second computer system 50 as schematically indicated by the double-headed arrow 30. The organizational architecture of the first computer system 12 includes a central processing unit (CPU) 12B in signal communication with a monitor 12C. The CPU 12B includes microprocessors, hard drive storage, RAM, and/or flash memory storage to store and execute software programs, including spreadsheet and/or database programs, for example Excel® and Access® programs. The second computer system 50 may include a monitor (not shown) and similarly includes microprocessors, hard drive storage, RAM, and/or flash memory storage to operate ERP related spreadsheet and/or database software, for example SAP®. The monitor 12C includes a series of screenshots that may be engaged by a pointer 13 manipulated by a nearby user. Engagement of screenshot or spreadsheet regions by the pointer 13 may be by using a computer mouse (not shown), by keyboard (not shown) entry, or by voice entry devices (not shown).

One of the screenshots is represented by the spreadsheet 14 of which data groups located on the spreadsheet 14 may be engaged by user-manipulation of the pointer 13. Residing in the CPU 12B is a local cache 18 that interacts with the spreadsheet 14 and an integration tool 16 residing in the CPU 12B. The double-headed arrow 30 indicates that the local cache 18 is in bi-directional signal communication with the second computer system 50. The screenshots on the monitor 12 pictographically represents the presentation of first computer 12's spreadsheet and/or database program-derived screenshots that may be in signal communication with spreadsheet and/or database ERP-related software programs located on the second computer 50. User interactions via the pointer 13 and call-in functions residing in the integration tool 16 populate spreadsheet subsections as will be described below. One of the screenshots is represented by the spreadsheet 14 of which data groups located on the spreadsheet 14 may be engaged by user-manipulation of the pointer 13. The integration tool 16 records user-manipulations of spreadsheets or screenshots, single and/or multiple, and sub-regions thereof. The local cache 18 receives master data files from ERP related software contained in the second computer 50 for populating data regions of the spreadsheet 14 selected or designated by user interaction via pointer 13 of the screenshot sections associated with the spreadsheet 14.

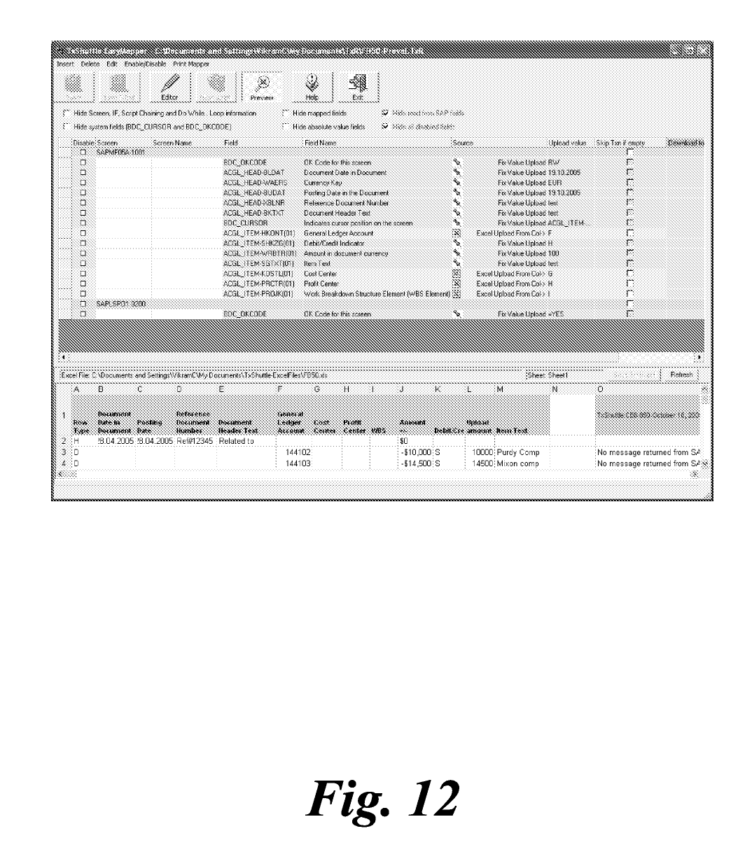

For every data element entered in the spreadsheet, such as a general ledger account, cost center, profit center, vendor number, etc., there is a possibility of error during the re-entry of the data. This possibility of error can be greatly reduced if the person using the spreadsheet has access to a list of possible values in each field of the ERP related spreadsheet and/or database contained within the second computer 50. Each such data element resides in a table in the second computer 50 systems' database. A user downloads the contents of the data in those master data tables into the local cached file 18 (into an XML file or a local database, for example). Then, for example, on an Excel column that contains that field, the user may press a button icon (not shown in FIG. 2 but shown in FIG. 12 below) to get a list of possible choices for that master data.

The software architecture of the system 10 permits the creation of the local data cache 18 to present the user with the correct master data options. The local cache 18 may be a small database that may be present on the first computer 12, generally the same computer where the integration tool and the spreadsheet is stored. Both the integration tool 16 and the spreadsheet 14 interact with the local cache 18 that stores the selected master data downloaded from ERP programs residing in the second computer system 50. The local cache 18 may be populated from the data subgroups derived from the second computer system 50 by user interaction of the pointer 13 and remote function call mechanisms within the integration tool 16 to the second computer system 50. The integration tool 16 also engages similar remote functions to affect bidirectional data transfers between the first computer system 12 and the second computer system 50. The double arrow 30 indicates the uploading or posting to the ERP related database and/or spreadsheet programs of the second computer system 50 and/or downloading from the second computer system 50 to the first computer system 12.

The software architecture may be configured to create the local data cache 18 and to present a user with the correct master data options. The local cache 18 of the client machine or first computer 12 may be a small database in which, generally is also stored the integration tool and spreadsheet programs. Both the automation transfer tool 16 and the spreadsheet interact with the local cache of the selected master data using a remote function call (RFC) process provided by the ERP-related software in the second computer system 50. The local cache 18 of the first computer 12 may be populated from data stored in the in the ERP related software of the second computer 50 using the RFC process. Alternatively, the RFC process may also be provided by an intervening server (not shown). The RFC process allows the spreadsheet and/or database software located in the first computer 12 to call or procure software processes from the ERP related software stored on the second computer system 50. Similar remote functioning of the computer 12's software integration tool from the second computer's 50 software may occur and bi-directionally between the first computer system 12 and secondary computer system 50 as indicated by the double arrow 30.

For example, if the user is entering data on the G/L account field, they can press a button to view the local list of all possible G/L account codes that the ERP system allows. Making the right choices at this stage minimizes the possible errors in the data that gets posted into the ERP system.

Alternate embodiments of the system 10 include configurations in which both the ERP (e.g. SAP®) and non-ERP (e.g. Excel®) spreadsheet and/or database software applications reside within the CPU of either the first computer system 12 or the second computer system 50. In such a system configuration the data integration tool 16 transfers or shuttles non-compatible data groupings between the ERP and non-ERP programs. The transfer or shuttles occurs in a manner described below such that the non-compatible data groupings become mutually recognizable and amenable to data processing by the ERP and non-ERP programs within the CPU.

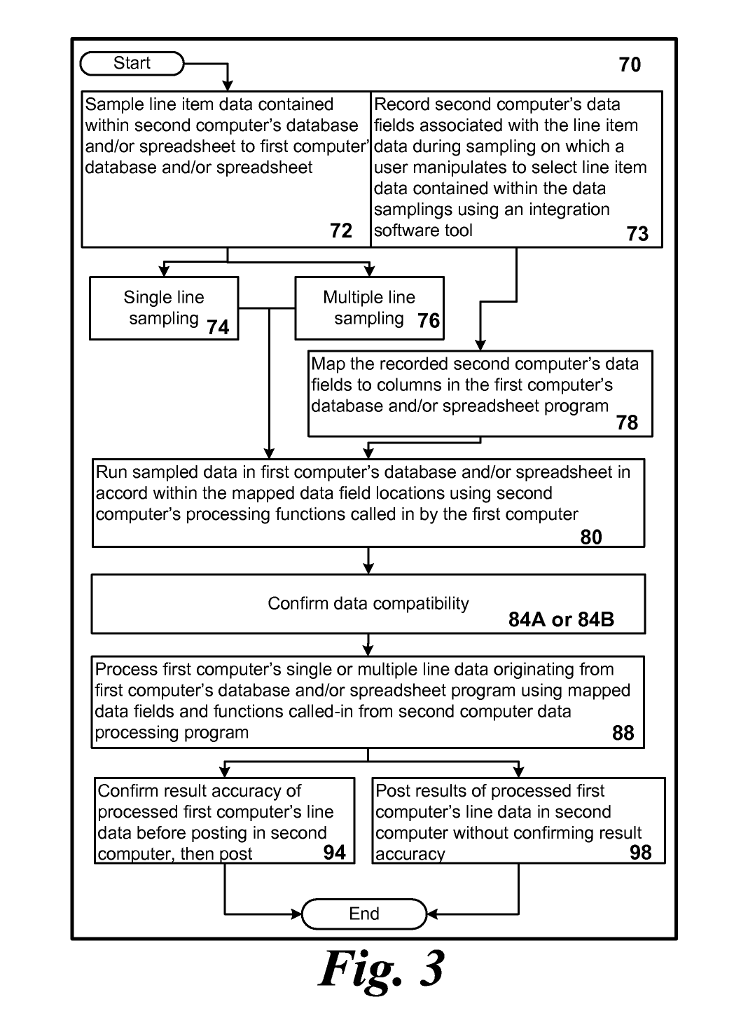

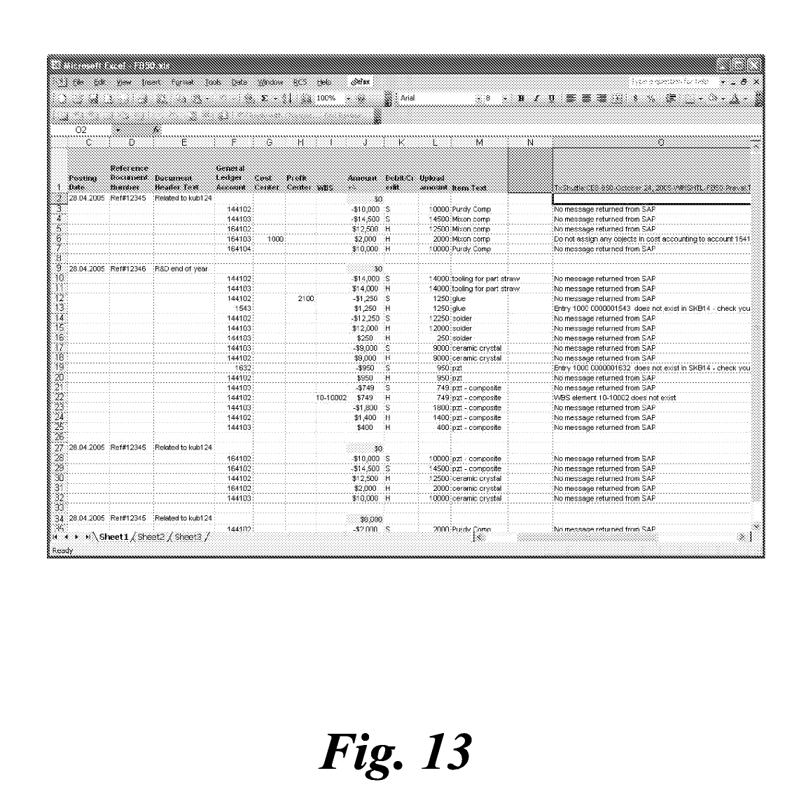

FIG. 3 illustrates a method of data integration between computer systems using single and multiple line sampling according to an embodiment of the invention. The method may be implementable in an electronic system coupled to an electronic device, the electronic device being coupled to a display device. The method is illustrated as a set of operations shown as discrete blocks. The method may be implemented in any suitable hardware, software, firmware, or combination thereof. The order in which the operations are described is not to be necessarily construed as a limitation. The method of data integration 70 begins with a sampling processing block 72 where sampling of the Second computer's 50 data file occurs either as a single line sampling shown in process block 74 or multiple line sampling, shown in process block 76. The single or multi-line sampling may be achieved by a user selecting data fields associated with the single or multiple line data. Screenshots similar to that as shown in FIGS. 13-17, described examples of a data field selection process, including setting up files. The data fields may be those that have association with the single or multiple line data. Adjacent to the sampling processing block is a record and mapping block 73. In the record and mapping block 73 resides the software integration tool 16 schematically depicted in FIG. 2. The software integration tool 16 includes record, mapping, and two-way call-in functions between the spreadsheet and/or database software programs operating from the first and second computers 12 and 50. The two-way call-in functions serves to establish the bi-directional transfer of data and program execution codes between the first and second computers 12 and 50. The software integration tool 16 monitors virtually simultaneously the user's data field selection process in which a user manipulates in screenshot regions to select data fields concerning the line data content associated with single or multiple line data. What recorded data fields that are manipulated by the user may be mapped in processing block 78. Thereafter, in process block 80, the sampled single and/or multiple line item data may be configured into a script to run within the first computer 12 with data processing programs obtained from the second computer using data processing functions called-in from the second computer's 50 programs using a remote function call function associated with the second computers spreadsheet and/or ERP related program. The running of the second computer's sampled data may be done within the mapped data field locations.

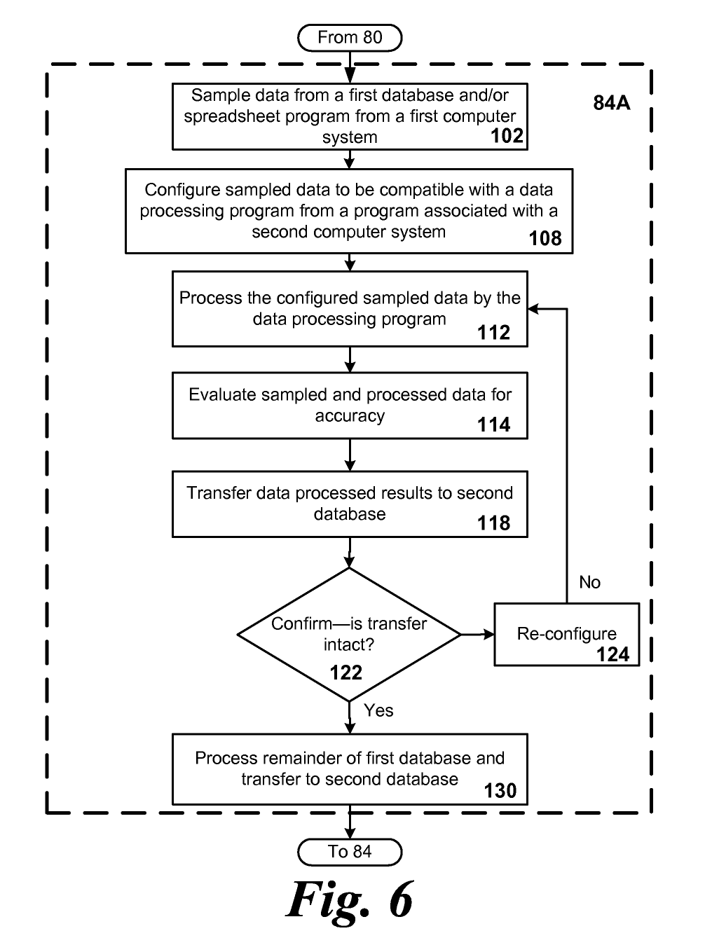

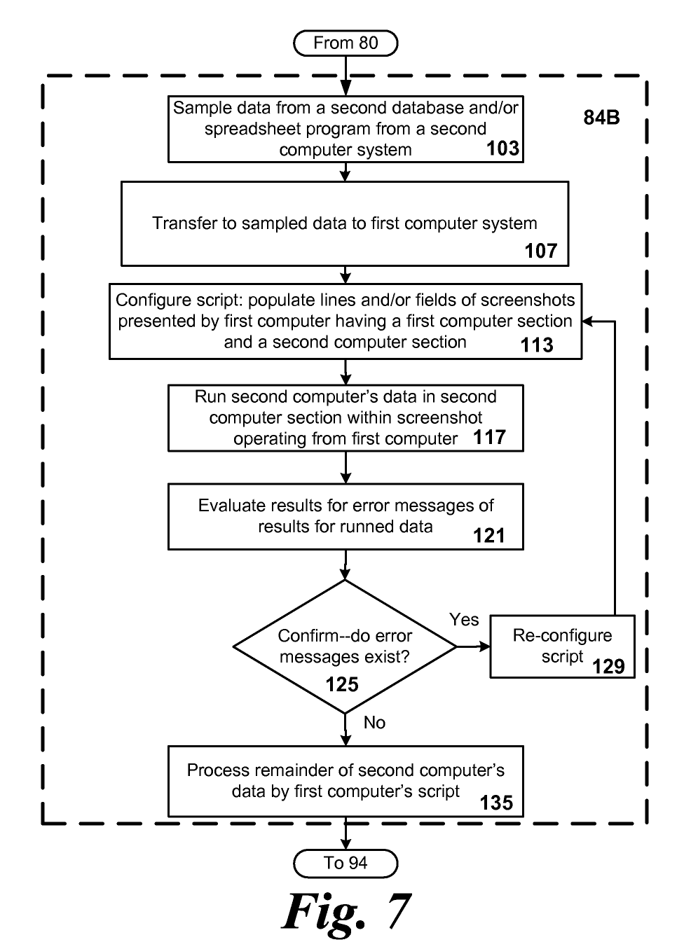

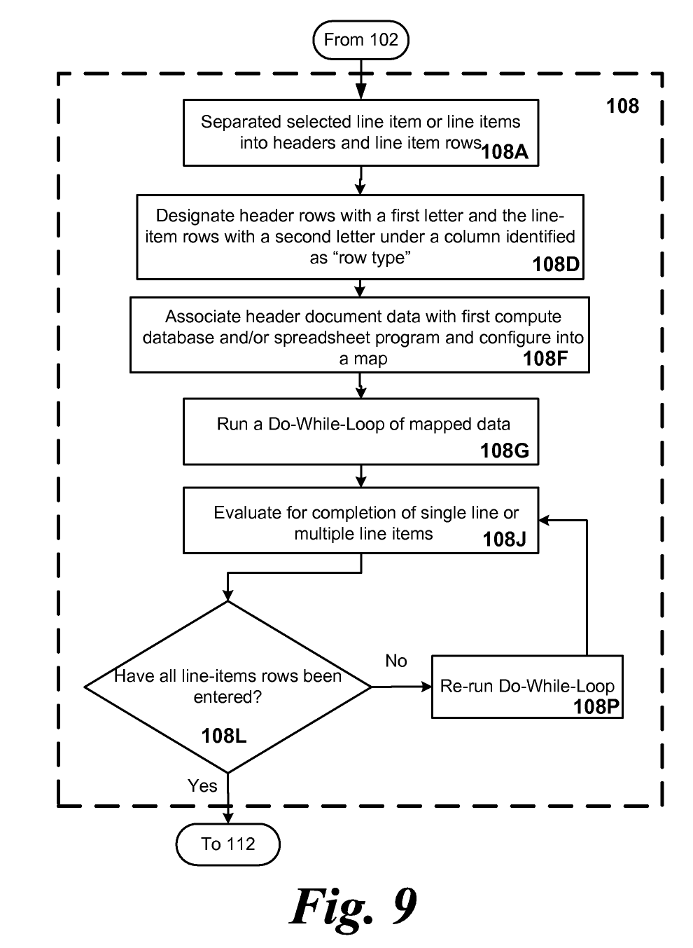

The data processed single and/or multiple line-sampled data is confirmed for data compatibility or accuracy by process block 84A or alternate process block 84B as further described respectively in FIGS. 6 and 7 below. If the first computer's 12 results are found accurate or compatible with the second computer's 50 remote data processing, the data integration method 70 proceeds to processing the first computer 12 single or multiple line data originating from the first computer's 12 database and/or spreadsheet programs in process block 88 using the mapped data fields and functions called-in from the second computer's 50 data processing programs, for example ERP database and/or spreadsheet programs. Data processing, as described more fully for FIG. 9 below, may incorporate a looping functionality applied for groups of multiple line items in which the number of items is not known a-priori. Thereafter, at process blocks 94 and 98, posting of the results of first computer 12's data processing into second computer' 50 database and/or spreadsheet is completed depending whether result accuracy of is confirmed before posting, process block 94, or posting is done without prior accuracy confirmation, process block 98. Confirmation of accuracy of processed results before posting allows a user to pre-validate or determine in advance whether single or multi-line items have calculation errors and/or error messages to a-priori known multi-line fixed data groupings, and/or to unknown a-priori variable data groupings. Upon posting, the data integration method 70 ends.

Alternate embodiments of the data integration method of FIG. 3 applies to the case when the system 10 includes the CPU of either the second computer system 50 and/or first computer system 12 that stores and operates ERP and non-ERP software stored.

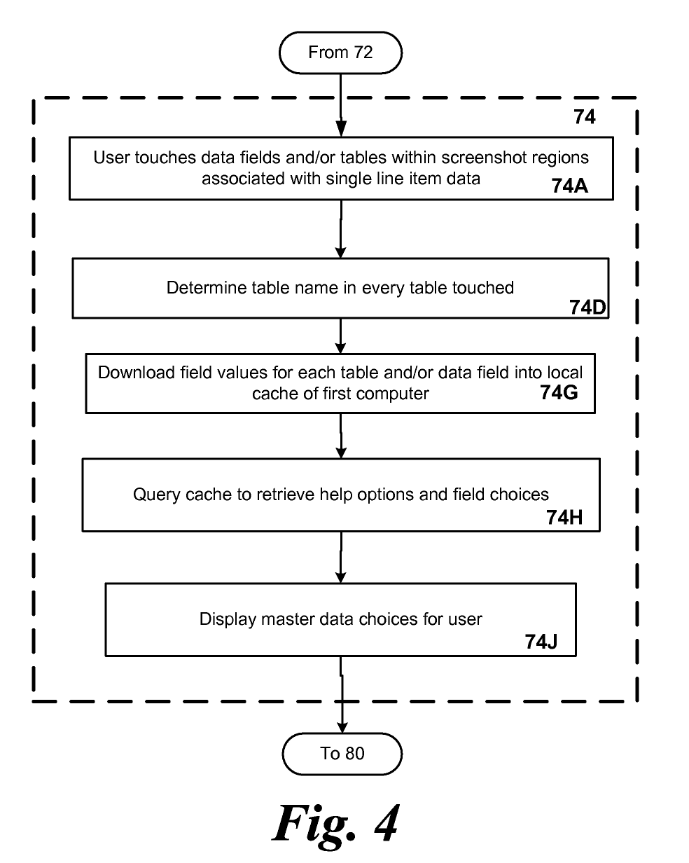

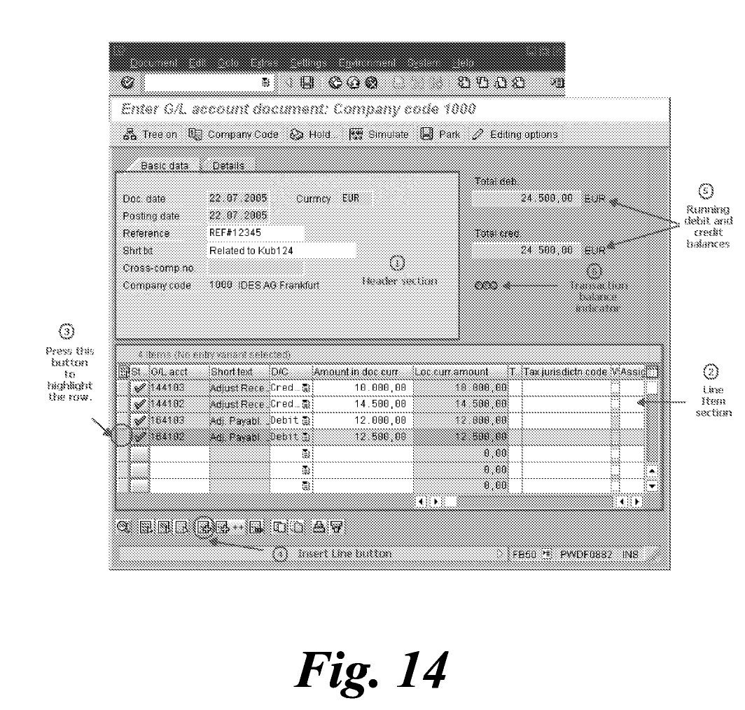

FIG. 4 is an expansion of sub-algorithm 74 of FIG. 3 relating to single line item data. Entering from process block 72, sub-algorithm 74 begins with process block 74A when a user touches data fields and/or tables contained within regions of a screenshot relevant to the database and/or spreadsheet software program associated with the second computer 50. The second computer 50 screenshot may be downloaded or imported from the second computer 50, or may reside in the local cache 18 of first computer 12 with call-in functioning to the programs residing in the second computer 50. Upon touching the data fields and tables, the integration tool 16 records those fields and tables touched by the user. Examples of data field and table selection touched by the user are exhibited in screenshots shown in FIGS. 14 -17 below. In process block 74D, the user determines the table name of every table touched. Thereafter, in process block 74G, the user downloads field values of each table and/or data field into local cache 18 of the first computer 12. The user than queries the local cache 18, as shown in process block 74H, to retrieve help option and/or data field choices. Then, at process block 74J, the user then selects options that culminate in displaying the master data choices for the user to process. Sub-algorithm 74 is then completed and exits to process block 80.

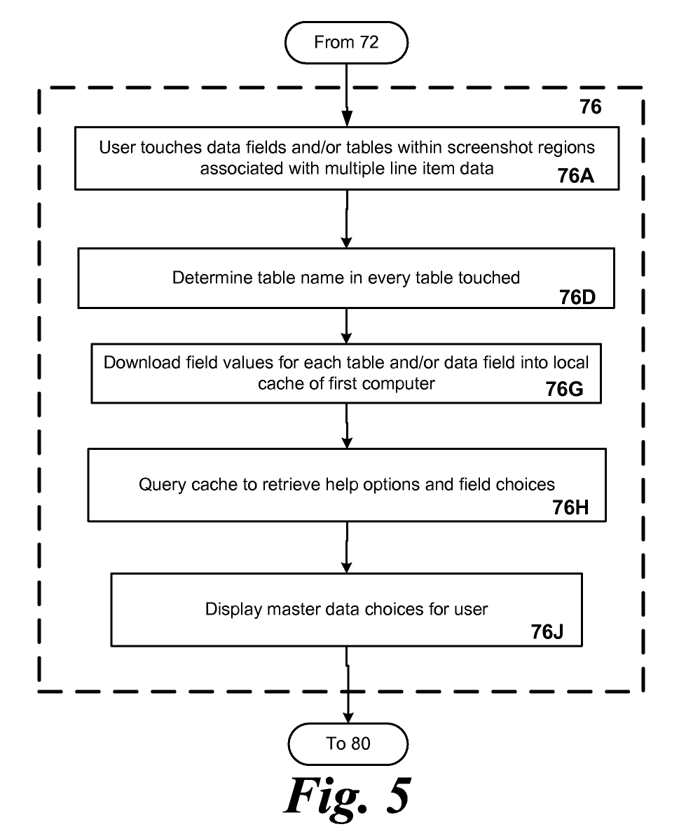

FIG. 5 is an expansion of sub-algorithm 76 of FIG. 3 relating to multiple line item data and is substantially similar to sub-algorithm 74. Entering from process block 72, sub-algorithm 76 begins with process block 76A when a user touches data fields and/or tables contained within regions of a screenshot relevant to the database and/or spreadsheet software program associated with the second computer 50. The second computer 50 screenshot may be downloaded or imported from the second computer 50, or may reside in the local cache 18 of first computer 12 with call-in functioning to the programs residing in the second computer 50. Upon touching the data fields and tables, the integration tool 16 records those fields and tables touched by the user. Examples of data field and table selection touched by the user are exhibited in screenshots shown in FIGS. 14 - 17 below. In process block 76D, the user determines the table name of every table touched. Thereafter, in process block 76G, the user downloads field values of each table and/or data field into local cache 18 of the first computer 12. The user than queries the local cache 18, as shown in process block 76H, to retrieve help option and/or data field choices. Then, at process block 76J, the user then selects options that culminate in displaying the master data choices for the user to process. Sub-algorithm 76 is then completed and exits to process block 80.

FIG. 6 is an expansion of sub-algorithm 84A of FIG. 3. This embodiment of the data integration method from a second computer system to a first computer system confirms accurate data transfer. The data integration method 100 concerns the data transfer from the second computer system 50 having ERP programs to the first computer system 12 having non-ERP programs. The data integration method 84A between the first 12 and second 50 computer systems operating non-compatible database and/or spreadsheet software programs utilize pre-validation or pre-quality control processing of data samples obtained from ERP system 50 programs within the database and/or spreadsheet located in the second computer 50. The method 84A utilizes several processing blocks or sub-algorithms and begins with sampling data from the first database and/or spreadsheet located on the second computer 50 at processing block 102 from an ERP related database and/or spreadsheet program. Thereafter, at processing block 108, the sampled data is configured to be compatible within the database and/or spreadsheet program located on the first computer 12. The processing block 108 uses a “Do-While-Loop” for multi-line data and is further described in FIG. 9. Then, at process block 112, the configured data is processed using the remote function call algorithms provided by the ERP programs obtained from the secondary computer 50 or operating from the first computer 12. Thereafter, at process block 114, the sampled and processed data is pre-validated or evaluated for accuracy. At process block 118, results from the data processing are transferred to the database located in the second computer. Thereafter, at decision diamond 122, a confirmation that transfers of processed sample data may be presented with query “Confirm-is transfer intact?”. If negative, then at process block 124, a reconfiguration of the sampled data is engaged and the method cycles back to process block 112. If positive for intact transfer of sample and second computer processed data, then at process block 130 the method 100 ends with processing the remainder of data located in the first computer 12's database and/or spreadsheet program by the methods employed upon the sampled data is engaged. Thereafter, algorithm 84A exits to process block 88 of FIG. 3.

FIG. 7 is an expansion of alternate sub-algorithm 84B of FIG. 3. This alternate embodiment of a data integration method from a second computer system to a first computer system confirms accurate data transfer and processing. Substantially similar to method 84A of FIG. 6, data integration method 84B utilizes pre-validation or pre-quality control processing of data samples operated under non-ERP system 12 programming within the database and/or spreadsheet located in the first computer 12. The method 84B utilizes several processing blocks or sub-algorithms and begins with sampling data from the second database and/or spreadsheet located on the second computer's 50 at processing block 103. Thereafter, at processing block 107, the sampled data is transferred to the first computer 12's non-ERP software and then configured to be compatible within the database and/or spreadsheet program located on the first computer 12 at process block 1 13. The processing block 107 uses a “Do-While-Loop” for multi-line data and is further described in FIG. 9. Then, at process block 113, the configured data is processed using the remote function call algorithms provided by the ERP programs obtained from the secondary computer 50 or operating from the first computer 12. Thereafter, at process block 117, the sampled and processed data is pre-validated or evaluated for accuracy. At process block 121, results from the data processing are transferred to the database located in the second computer 50. Thereafter, at decision diamond 125, a confirmation that error messages exist may be presented with the query “Confirm-do error messages exist?” at decision diamond 125. If affirmative for the presence of error messages, then at process block 129, a reconfiguration of the script is accomplished be re-population of lines and /or fields within screenshots is engaged by cycling back to process block 113. If negative for the presence of error messages, method 84B exits to process block 88 of FIG. 3.

Methods 84A and 84B described for FIGS. 6 and 7 respectively, may be adapted to apply the one-way data transfers, or alternatively for two-way transfers, between first computer 12 and second computer 50. The one or two-way transfer may be achieved by using the integration tool 16 defined within the software code contained in the TxShuttle® software product, available from Winshuttle Inc., Bothell WA. Using the integration tool 16 advantageously enhances the following:

1. Downloading a sampling of the transaction data stored in the second computer system's ERP spreadsheet and/or database and save-to or record in the first computer system's spreadsheet and/or database programs in a manner that mimics manual reentry of data but at high speeds greater than manual entry as described in FIG. 5 below. Thereafter, again using the data transfer tool, the sampled transaction data may be populated into screens and data elements as directed, either for single line or multiple line entry groups. During the sampling download, the transfer tool records the various actions and the data fields that a user manipulates;

2. Mapping a script of the recorded ERP fields from the second computer system to columns in the first computer's spreadsheet and/or database, for example, Microsoft's Excel® and Microsoft's Access®, respectively, within the same or a series of screenshots. This mapping may be done using the transfer tool that involves simple drag-and-drop process where the recorded ERP fields may be dragged and dropped into the Excel® and/or Access® fields;

3. Running the transactions of the recorded and mapped script as many times as necessary for until all the rows of data in the Excel® spreadsheet and/or Access® databases may be run using the transfer tool, each time uploading into the ERP fields of the second computer system with Excel fields from the first computer system; and

4. Recording any transaction run upload error messages generated by the second computers ERP spreadsheet and/or database by line item to the first computer's spreadsheet and/or database program, i.e., Excel® and Microsoft's Access®, respectively.

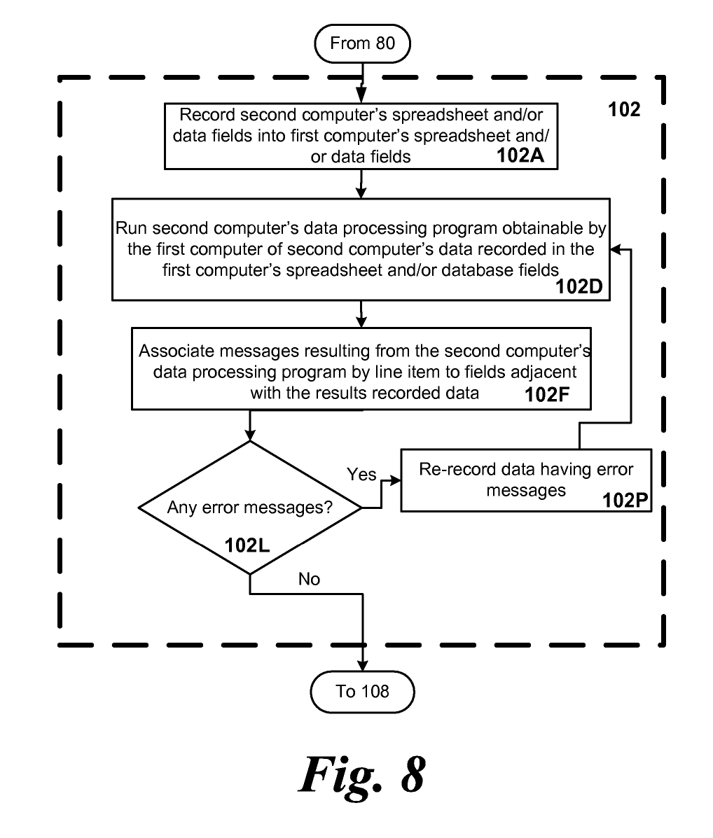

FIG. 8 is an expansion of sub-algorithm 102 of FIG. 6. The sampling an ERP associated data begins with process block 102A wherein data from the second computer's 50 spreadsheet and/or database is placed into the data fields within the first computer's 12 spreadsheet and/or database program. Thereafter, at process block 102D, the data processing program of the second computer 50 is run or executed on the second computer's 50 data stored within the first computer's 12 spreadsheet and/or database. In process block 102F, messages are associated from the second computer's 50 data processing program by line item to fields adjacent with the results of the recorded data contained within the first computer 12. For example, messages returned from an SAP® program running on the second computer 50 may be logged into an Excel® file along with the results of the Excel® processed data to conveniently provide a self-documented record of data integration at this stage. At decision diamond 102L, a query “An error messages” is presented. If affirmative for error messages, then data having error message are re-recorded at process block 102P and re-run at process block 102D. If negative for error message, sub-algorithm 102 is completed and exits to sub-algorithm 94.

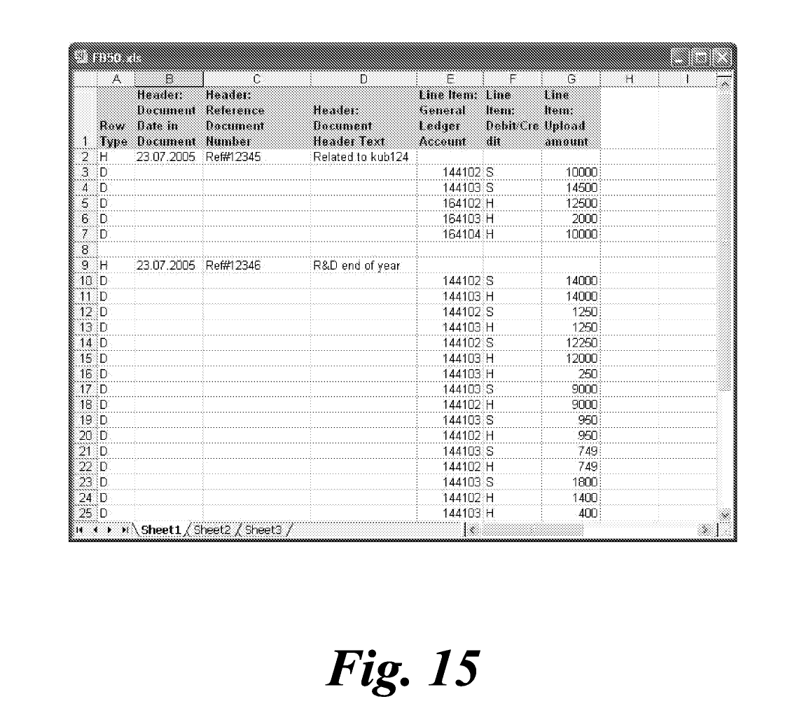

FIG. 9 is an expansion of sub-algorithm 108 of FIG. 6. The loading of multi-line data presents incompatibilities and complexities that are made simple and compatible by using a Do-While-Loop process within sub-algorithm 108. From process block 102, the Do-While-Loop begins at process block 108A wherein those data lines not having error messages are selected and separated into headers and line item rows. The selected error-message free line items may be than mapped to associate headers and line items within the first computer's 12 spreadsheet and/or database program at process block 108F. The designation process includes identifying the header rows with a first letter, for example the letter H, and line-item rows with a second or different letter, for example the letter D. The designation into different letter descriptors may be tabulated within a column labeled “row type” as shown exemplary screenshot of FIG. 15 below. Thereafter, a Do-While-Loop process may be applied to the mapped data at process loop 108G. Completion of the Do-While-Loop at process block 108J may be achieved by seeking an answer the query presented in decision diamond 108L, “Have all line rows been entered?” If negative all line row entry, the Do-While-Loop is re-run at process block 108P and re-evaluated at process block 108J and decision diamond 108L. Upon affirmatively confirming that all line row data is entered in the first computer's 12 spreadsheet and/or database programs, sub-algorithm 108 is complete and exits to process block 112.

The speed of the integration tool 16 in achieving data reentry is commonly 100-fold faster than manual reentry. The transfer tool's 16 speed depends on the number of field and records for entry into the first computer's 12 spreadsheet and/or database program as the combination of fields and records determines the number of H rows and D rows requiring creation. Typically, for records having 10 line-items (D rows) and assuming that each line includes 3 fields each, the automation transfer tool 16 commonly processes 500 records within an hour, depending on microprocessor central processing unit (CPU) speed of the first computer 12, the operational intranet or internet CPU speeds of any intermediate positioned servers, the CPU speed of the second computer 50, and the number of users in active signal communication with the second computer 50. By comparison, manual reentry would only be able to do about five records per hour.

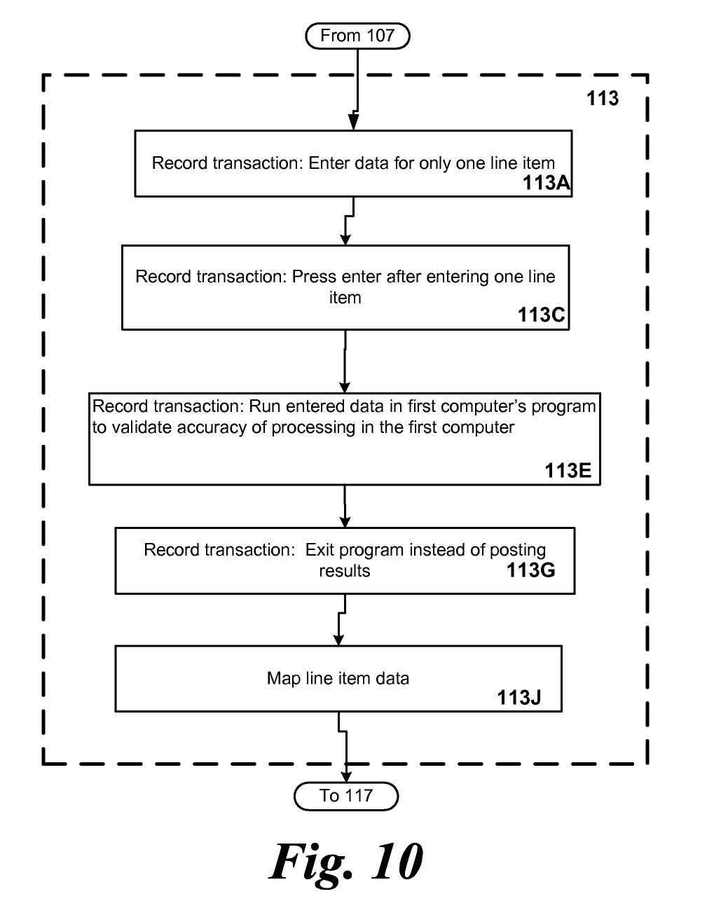

FIG. 10 is an expansion of sub-algorithm 113 of FIG. 7. Entering from processing block 107, sub-algorithm 113 begins with processing block 113A in which a record transaction event occurs of entering data in the form of a one line item. In the following processing block 113C, another record transaction event in the form of the user pressing an enter key or equivalent command for commencement of processing upon the one line item. In processing block 113E, another record transaction event occurs by the running of the first computer's 12 spreadsheet and/or database program to verify accuracy of processing in the first computer 12. Another record transaction event occurs in processing block 113G defined by the early exiting of the processing program instead of posting the results. There after, at processing block 113J the line item data is mapped and sub-algorithm 113 is finished and exits to processing block 117.

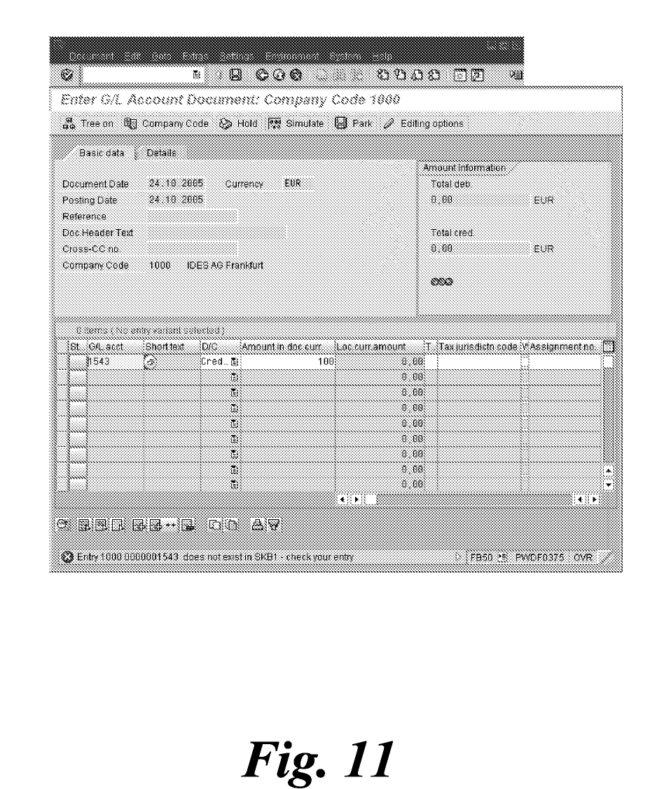

FIG. 11 depicts a screenshot of a general ledger ERP screen as an example of pre-validating a single line item data prior to posting. Consistent with the process block 94 of data integration method of FIG. 3, a general ledger (G/L) file screenshot of an ERP program is presented. All the line item fields that need to be pre-validated can be mapped to the same spreadsheet that will be used for posting. The title bar states “Enter G/L Account Document: Company Code 1000”. An option bar beneath the title bar has push buttons Tree on, Company Code, Hold, Simulate, Park, and Editing options.

FIG. 12 depicts a screenshot of the integration tool mapping the general ledger fields to a spreadsheet file as an example of pre-validating the multiple lines of selected spreadsheet files data prior to posting consistent with the process block 94 of data integration method of FIG. 3. In this screenshot example of the TxShuttle™ EasyMapper, an SAP table and an Excel table is shown. The preview icon may be engaged and mapping is shown for the G/L account, the profit center, cost center, and any work breakdown structure (WBS) elements for identifying project tasks. What fields are displayed are controlled by check boxes Hide Screen, Hide system fields, Hide mapped fields, Hide absolute value fields, Hide read from SAP fields, and Hide all disabled fields. Beneath the check boxes is a table with headings Disable, Screen, Screen Name, Field, Field Name, Source, Upload value, Skip Txn (transaction) if empty, and Download to. In the upper table is the SAP® file listings classified under the column headings above. Four fields are selected for prevalidation beneath the sources column, with the denotation of fields selected for prevalidation are checked with a highlighted X enclosed within a square box. The four selected fields are listed in the Excel® table.

FIG. 13 depicts a screenshot demonstrating the results of prevalidation of the selected files from FIG. 12. The output log from the ERP system pinpoints exactly which line items have errors and what the errors define. The listing of accounts, which have errors, associated with particular line items are shown in Column O. For general ledger account numbers that do not exhibit error messages, the phrase “No message returned from SAP”. However, four general ledger accounts exhibit error messages. Account 164103, an error message “Do not assign any objects in cost accounting to account 164103. General ledger accounts 144102-1543 and 144102-1632, the error message “Entry does not exist”. Account 144102 has error message “WBS elements does not exist”.

FIGS. 14-17 presents a series of screen shots related to the Do-While Loop feature of the integration tool 16. In view of FIG. 2, a user views the values of data fields of the second computer 50 ERP stored data by downloading under the remote call in functioning. The contents of master data located in the ERP related spreadsheet and/or database of the second computer 50 is downloaded in the local cache file 18 of the first computer 12. The downloading may be conveniently accomplished as extended markup language XML file, the content of which is shuttled or transferred to an Excel® file. The user reviews, via the integration tool 16, the ERP based master data stored in the local cache file 18 of the first computer system 12. As shown in FIG. 14, an example of screens and data elements are viewed and executed in order to record sample ERP related transactions, for example an SAP® General Ledger transaction. The integration tool 16 records what the user selects via pointer 13 from the SAP fields and shuttles or transfers these ERP master data fields to first computer's 12 spreadsheet and/or database programs to determine the optimal values choices to minimize the first computer 12's data processing errors prior to posting back to the ERP related spreadsheet and/or databases in the second computer 50. As shown in FIG. 13, the integration tool 16 captures the names of the tables and table field being recorded and maps them in the EasyMapper™ sub-tool by the drag and drop procedures the user engages via the pointer 13. After extracting the table name and field names for each recorded field, the integration tool 16 queries the ERP related spreadsheet and/or database programs and downloads the data relevant to those fields ERP fields into the first computer's 12 spreadsheet and/or database programs.

FIG. 14 is a screenshot of ERP-processed transactional data resulting from the sub-algorithm 108 described in FIG. 9 for formatting the ERP spreadsheet and/or database data from the second computer 50 in a way that separates header row designations and line-item rows. The loading of multi-line data presents incompatibilities and complexities that are made simple and compatible by using the Do-While-Loop as described in sub-algorithm 108. This screenshot shows an SAP journal voucher with header data and various line items. Under the title bar that states “Enter G/L account document: Company code 1000” is a header section with the “Basic data” tab in view showing data entry fields, including document (doc) date, Posting date, Reference number, Short text, Cross-comparison number, and Company code. Beneath the header section is a line item section in tabular form having ten columns, the left most side being engagable as a pressable push button by the pointer 13 to select one of the G/L accounts—164182. Beneath the line item section is a tool bar panel with “insert line button” circled. Selection of the 164182 accounts shows the running debit and credit balances in data windows adjacent to the header section.

FIG. 15 is a screenshot of multi-line data in a spreadsheet categorized against header data in preparation for processing by the Do-While-Loop. The header data from the header section of the ERP screenshot of FIG. 14 imported from the second computer 50 is mapped to the Excel® file run on first computer 12. The mapped Excel® file is marked with a letter H and the related line-item data is marked on rows with the letter D.

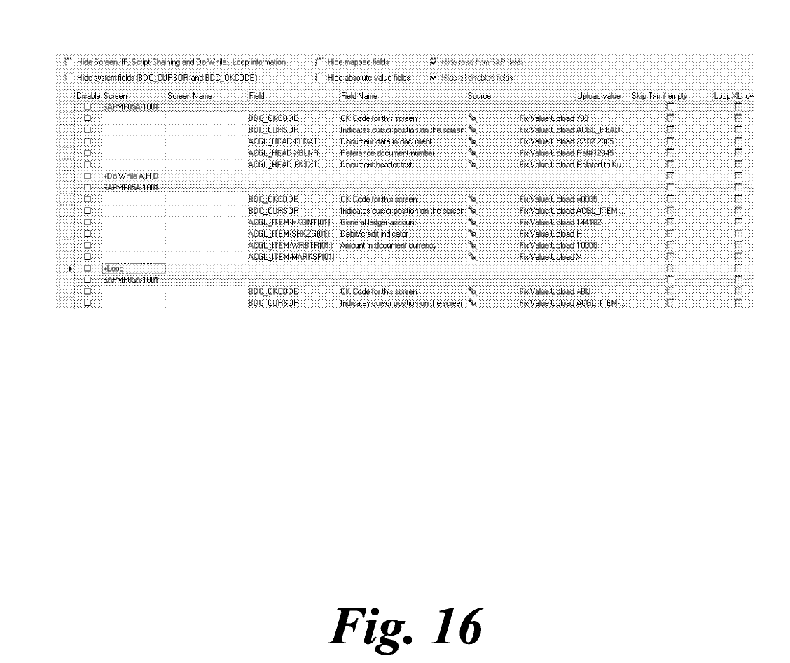

FIG. 16 is a portion of an integration tool screenshot of a looping around procedure mapped from the multi-line data of FIG. 15. Mapping to integration tool's 16 TxShuttle®, this screenshot displays the operation of the Do-While-Loop under the scenario when the SAP fields are hidden and disabled fields are hidden as indicated by the checked boxes. The mapped data reconfigures the Do-While-Loop to loop around each line item recorded.

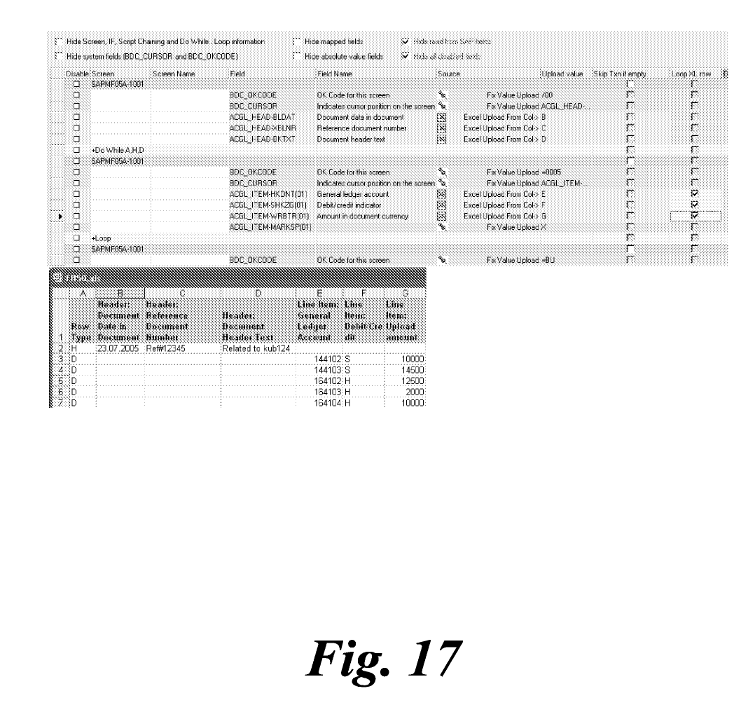

FIG. 17 is a portion of screenshot of the looping around procedure within the integration tool's 16 TxShuttle® and a partial Excel® screenshot mapped from the integration tool 16. Consistent with process block 108 of FIG. 3, single line item mapping is accomplished engagement of the Do-While-Loop.

While the particular embodiments have been illustrated and described for integration of data between first and second computer systems, for example organization computers and computers operating central ERP database programs, many changes can be made without departing from the spirit and scope of the invention. For example, the systems and methods described may be similarly applied to integrate data between non-compatible first computers or non-compatible ERP database run computers. Accordingly, the scope of embodiments of the invention is not limited by the disclosure of the particular embodiments. Instead, embodiments of the invention should be determined entirely by reference to the claims that follow.

The embodiments of the invention in which an exclusive property or privilege is claimed are defined as follows:

1. A method for integrating information between databases comprising:
sampling data from a first database;
configuring the sampled data within the first database into a form recognizable by a second database;
transferring the sampled and configured data to the second database; and if transfer is successful
processing the remainder of the data from the first database by the same procedure used for the sampled data.

2. The method of claim 1, wherein configuring the sampled data includes performing a looping run to the data of the first database.

3. A method for integrating information between databases comprising:
sampling data from a first database;
procuring data processing instructions from a second database;
configuring the sampled data within the first database into a form recognizable by the processing instructions of the second database;
executing the data processing instructions of the second database on the sampled and configured data to generate processing results;
transferring the processing results to the second database; and if transfer is successful,
processing the remainder of the data from the first database by the same procedure used for the sampled data.

4. The method of claim 3, wherein configuring the sampled data includes performing a looping run to the data of the first database.

5. A method for integrating information between databases comprising:
sampling data from a first database;
procuring data processing instructions from a second database;
configuring the sampled data within the first database into a form recognizable by the processing instructions of the second database;
executing the data processing instructions of the second database on the sampled and configured data to generate processing results;
examining the processing results of the sampled data for accuracy;
transferring the processing results to the second database; and
if transfer is successful, processing the remainder of the data from the first database by the same procedure used for the sampled data.

6. The method of claim 5, wherein configuring the sampled data includes performing a looping run to the data of the first database.

7. The method of claim 6, wherein the looping run is performed on single line items and multiple line items.

8. A system for integrating data between databases comprising:
a first computer system having a database; and
a second computer system in signal communication with the first computer system and having a second database and processing instructions;
wherein at least a portion of the first database is made to be recognizable by the processing instructions.

9. The system of claim 8, wherein the portion of the first database is made recognizable by the processing instructions within the first database.

10. The system of claim 9, wherein the recognizable first database receives executed instructions from the second database while residing in the first computer system.

11. The system of claim 10, wherein the recognizable first database is transferred to the second database before execution of processing instructions.

12. A computer-readable medium having computer-executable instructions for performing a method comprising:
sampling data from a first database;
configuring the sampled data within the first database into a form recognizable by a second database;
transferring the sampled and configured data to the second database; and if transfer is successful
processing the remainder of the data from the first database by the same procedure used for the sampled data.

13. The method of claim 12, wherein configuring the sampled data includes performing a looping run to the data of the first database.

14. A computer-readable medium having stored thereon a data structure comprising:
a mapping tool having a do-while loop including:
a first field having first data elements selected from a first computer system;
a second field having second data elements selected from a second computer system;
wherein the first and second fields of the mapping tool is displayed in a user interface.

15. The computer-readable medium of claim 14, wherein the do-while loop verifies that conditions associated by the second field is met by data elements of the first field and that conditions associated by the first field is met by data elements of the second field.

16. A set of application program interfaces embodiment on a computer-readable medium for execution on a computer in conjunction with an application program that integrates data between databases comprising:
a first interface having:
a first field having first data elements selected from a first computer system;
a second field having second data elements selected from a second computer system;
a second interface having an at least one data line having an alphanumeric prefix applied to the second data elements for execution by a data processing program stored on the second computer;
wherein the results of the data processing program is listed in a location visible in the first field.

17. The set of application program interfaces of claim 16, wherein an error message of the data processing program is listed adjacent to the location visible in the first field.
